(19) United States
(12) Patent Application Publication
(10) Pub. No.: US 2012/0259724 A1
(43) Pub. Date: Oct. 11, 2012

(54) Seller Initiated Incentives Based on Profile Information

(75) Inventor: Srinivasan Raman, Cupertino, CA (US)

(73) Assignee: eBay Inc., San Jose, CA (US)

(21) Appl. No.: 13/082,749

(22) Filed: Apr. 8, 2011

(51) Int. Cl. G06Q 30/00

(52) U.S. Cl. 705/26.3; 705/26.1

(57) ABSTRACT

In an example embodiment, a method at a network-based commerce system is provided. Here, the network-based commerce system facilitates a transaction of an item between a seller and a buyer. In this method, the buyer who has indicated interest in the item offered by the seller is identified. The buyer has not previously provided to the seller a profile associated with the buyer. The profile associated with the buyer is accessed, and this profile is communicated to the seller. Thereafter, an incentive from the seller is received, and this incentive is made based on the communication of the profile to the seller. The incentive is then communicated to the buyer.

### COPYRIGHT NOTICE

A portion of the disclosure of this patent document contains material that is subject to copyright protection. The copyright owner has no objection to the facsimile reproduction by anyone of the patent document or the patent disclosure as it appears in the Patent and Trademark Office patent files or records, but otherwise reserves all copyright rights whatsoever. The following notice applies to the software and data as described below and in the drawings that form a part of this document: Copyright 2011, eBay Inc. All Rights Reserved.

### FIELD

The present disclosure relates generally to transactions conducted on electronic systems. In some example embodiments, the disclosure relates to seller initiated incentives based on profile information.

### BACKGROUND

Many electronic commerce systems facilitate transactions of items between users. For example, many users buy and sell products and services over the Internet or other computer networks through a third party commerce system. In many of these commerce systems, a user can add one or more items to a watch list, which is a list of items that require close surveillance for possible action in the future. From the sellers' side, the sellers that have listed items on a commerce system may only see a count of the number of users that have added the items to their watch lists.

### BRIEF DESCRIPTION OF DRAWINGS

The present disclosure is illustrated by way of example and not limitation in the figures of the accompanying drawings, in which like references indicate similar elements and in which:

FIG. 1 is a diagram depicting a network-based commerce system facilitating transactions between buyers and sellers;

FIG. 2 is a network diagram depicting a client-server system, within which various example embodiments may be deployed;

FIG. 3 is a block diagram of an item incentive module, in accordance with some embodiments of the present invention;

FIG. 4 is a flow diagram of a general overview of a method, in accordance with an embodiment, for facilitating a transaction of an item between the seller and a buyer;

FIGS. 5A and 5B are graphical user interfaces illustrating the identification of a buyer indicating interest in an item offered by the seller, in accordance with an example embodiment;

FIG. 6 is another graphical user interface illustrating the identification of a buyer indicating interest in an item offered by the seller, in accordance with another example embodiment;

FIG. 7 is a message-sequencing diagram illustrating various messages transmitted between a buyer and a seller in the transaction of an item, in accordance with some embodiments of the present invention;

FIG. 8 depicts a flow diagram of a method, in accordance with some alternate embodiments, for facilitating a transaction of an item between a seller and a buyer; and

FIG. 9 depicts a block diagram of a machine in the example form of a processing system within which may be executed a set of instructions for causing the machine to perform any one or more of the methodologies discussed herein.

### DETAILED DESCRIPTION

The description that follows includes illustrative systems, methods, techniques, instruction sequences, and computing machine program products that embody illustrative embodiments of the present invention. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures and techniques have not been shown in detail.

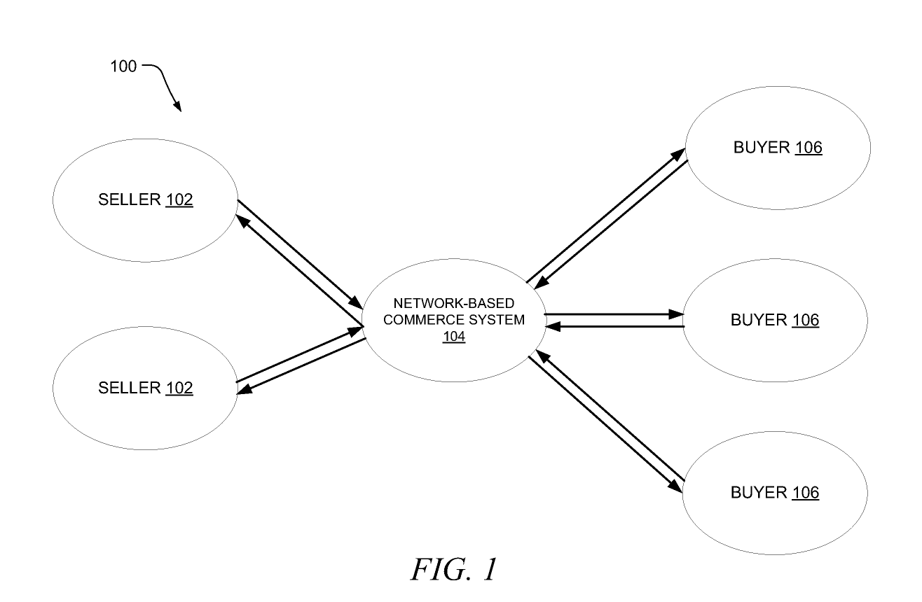

FIG. 1 is a diagram depicting a network-based commerce system 104 facilitating transactions between buyers 106 and sellers 102. Here, the network-based commerce system 104, which may also be referred to as an electronic commerce platform, provides a number of publishing, listing and price-setting mechanisms, whereby one or more sellers 102 may list (or publish information concerning) items for sale, one or more buyers 106 can express interest in or indicate a desire to purchase such items, and a price can be set for a transaction pertaining to the items. As used herein, an “item” refers to any tangible or intangible thing or something that has a distinct, separate existence from other things. Examples of items include goods, services, electronic files, and land. It should also be noted that a “transaction” refers to an instance or process of carrying on or conducting business. In one example, the network-based commerce system 104 can facilitate an online auction system where users or participants can bid for items over the Internet. In this instance, transactions can include a seller making a bid (or offer) or accepting a bid (or offer). In another example, buyers 106 can directly buy items from sellers using the network-based commerce system 104 over the Internet.

In some embodiments of the present invention, sellers 102 can use the network-based commerce system 104 to provide additional incentives for buyers 106 to purchase their items. For example, as explained in more detail below, the network-based commerce system 104 can communicate profiles of the buyers 106 to the sellers 102. Based on the profiles, sellers 102 can initiate additional incentives to one or more of the buyers 106 to further motivate the buyers 106 to purchase or bid on their items.

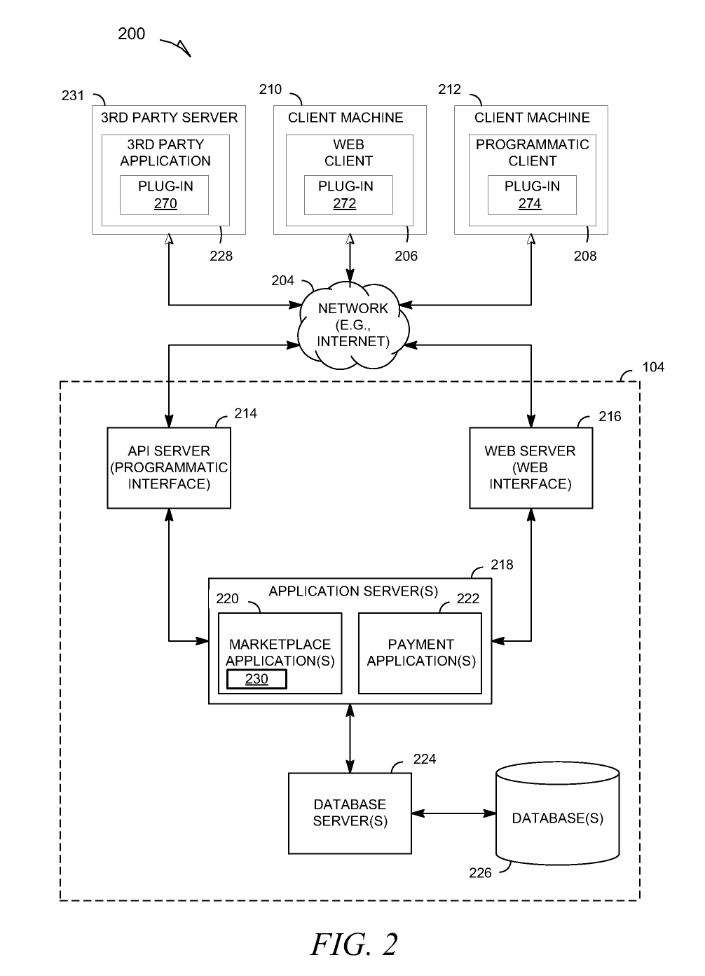

FIG. 2 is a network diagram depicting a client-server system 200, within which various example embodiments may be deployed. Here, a network-based commerce system 104, in the example form of a network-based marketplace or other publication system, provides server-side functionality, via a network 204 (e.g., the Internet or Wide Area Network (WAN)) to one or more client machines 210 and 212. FIG. 2 illustrates, for example, a web client 206 (e.g., a Web browser) and a programmatic client 208 executing on respective client machines 210 and 212. Each client machine 210 or 212 may include a software application module (e.g., a plug-in, add-in, or macro) that adds a specific service or feature to a larger system. The software application module may be separate from, but tightly integrated into, a user interface and functionality of a software application, such as a Web browser. The software application may be a client software application running on a client machine 210 or 212. For example, FIG. 2 depicts plug-ins 272 and 274 as being included in the web client 206 and the programmatic client 208, respectively. The software application module may be optionally deployed in the same environment as the software application such that the software application module can be accessed from within the software application. The software application module may be optionally enabled or disabled within the environment (e.g., user interface) of the software application. The software application module may appear to be a part of the software application by, for example, providing user interface components or widgets (e.g., menus, toolbars, menu commands, and toolbar commands) that can be enabled, disabled, added to, or removed from standard user interface components or widgets provided by the software application.

FIG. 2 also illustrates a third party application 228, executing on a third party server machine 231, as having programmatic access to the network-based commerce system 104 via the programmatic interface provided by an application programming interface (API) server 214. For example, the third party application 228 may, utilizing information accessed from the network-based commerce system 104, support one or more features or functions on a website hosted by the third party. The third party website may, for example, provide one or more promotional, marketplace or payment functions that are supported by the relevant applications of the network-based commerce system 104. FIG. 2 depicts a plug-in 270 as being included in the third party application 228.

In the network-based commerce system 104, the API server 214 and the web server 216 are in communication with, and provide programmatic and web interfaces respectively to, one or more application servers 218. In this example, the application servers 218 host one or more marketplace applications 220 and payment applications 222. The application servers 218 are, in turn, shown to be coupled to or in communication with one or more database servers 224 that facilitate access to one or more relational or non-relational databases 226.

The payment applications 222 provide a number of payment services and functions to users. For example, the payment applications 222 may allow users to accumulate value (e.g., in a commercial currency, such as the U.S. dollar, or a proprietary currency, such as “points”) in accounts, and then later redeem the accumulated value for making payments via the marketplace applications 220.

The marketplace applications 220 may provide a number of marketplace functions and services to users that access the network-based commerce system 104. An example of a marketplace application 220 is an online auction application that provides a number of features in support of various auction-format listings. Another example includes a fixed-price application that supports fixed-price listing formats (e.g., advertisement-type listings or catalogue listings) and buyout-type listings. Another example of a marketplace application 220 is a listing creation and management application that allows sellers to conveniently author listings pertaining to goods or services that they wish to transact via the network-based commerce system 104 and allows sellers to manage such listings. A messaging application is also another type of marketplace application 220 that is responsible for the generation and delivery of messages to users of the network-based commerce system 104. For example, the messaging application may deliver electronic mail (e-mail), instant message (IM), Short Message Service (SMS), text, facsimile, or voice (e.g., Voice over IP (VoIP)) messages via wired (e.g., the Internet, Plain Old Telephone Service (POTS)), or wireless (e.g., mobile, cellular, WiFi, WiMAX) networks. In some embodiments, the marketplace applications 220 also include an item incentive module 230 that, as explained in more detail below, allows sellers to initiate or provide additional incentives to one or more buyers based on profile information.

While the marketplace and payment applications 220 and 222 are shown in FIG. 2 to both form part of the network-based commerce system 104, it will be noted that, in alternative embodiments, the payment applications 222 may form part of a payment service that is separate and distinct from the network-based commerce system 104. Further, while the system 200 shown in FIG. 2 employs a client-server architecture, embodiments of the present invention are, of course, not limited to such an architecture, and could equally well find application in a distributed, or peer-to-peer, architecture system, for example. The various marketplace and payment applications 220 and 222 could also be implemented as standalone software programs, which do not necessarily have networking capabilities.

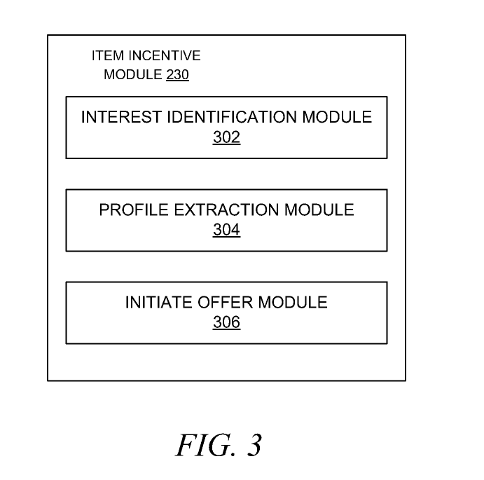

FIG. 3 is a block diagram of the item incentive module 230, in accordance with some embodiments of the present invention. The item incentive module 230 may be executed or included in a network-based commerce system (such as the network-based commerce system 104 depicted in FIG. 2). For example, in an embodiment, the item incentive module 230 may form a part of the application servers 218 depicted in FIG. 2. In various embodiments, the item incentive module 230 may be used to implement computer programs, logic, applications, methods, processes, or software to facilitate transactions between sellers and buyers, as described in more detail below.

In the embodiment depicted in FIG. 3, the item incentive module 230 includes an interest identification module 302, a profile extraction module 304, and an initiate offer module 306. The interest identification module 302 is configured to identify a buyer that has indicated interest in an item offered by a seller through the network-based commerce system. As used herein, a user can indicate an “interest” by taking an action to draw of the seller. As explained in more detail below, a buyer can indicate interest in an item by, for example, adding the item to a watch list or a shopping cart.

The profile extraction module 304 is configured to extract a profile of a buyer that has been identified to have indicated interest in the item. A “profile” refers to one or more characteristics, qualities, descriptions, or actions that can be associated with a user. It should be noted that a “profile” may also be referred to as “profile information” and therefore, the two terms may be used interchangeably. Examples of profile information include the buyer's search history, purchase history, gender, location, and occupation.

The initiate offer module 306 is configured to communicate messages between the seller and the buyer. In some embodiments, the initiate offer module 306 can communicate the buyer's profile, which has been extracted by the profile extraction module 304, to a seller. Additionally, the initiate offer module 306 can communicate an incentive to the buyer. As explained in more detail below, the seller can initiate this incentive, which is made in addition to the previous offer, based on the profile provided by the profile extraction module 304.

It should be appreciated that in other embodiments, the item incentive module 230 may include fewer or more modules apart from those shown in FIG. 3. For example, in an alternate embodiment, the initiate offer module 306 can be integrated within the interest identification module 302. The modules 230, 302, 304, and 306 may be in the form of software that is processed by a processor. In another example, as explained in more detail below, the modules 230, 302, 304, and 306 may be in the form of firmware that is processed by application specific integrated circuits (ASICs), which may be integrated into a circuit board. Alternatively, the modules 230, 302, 304, and 306 may be in the form of one or more logic blocks included in a programmable logic device (for example, a field programmable gate array). The described modules 230, 302, 304, and 306 may be adapted, and/or additional structures may be provided, to provide alternative or additional functionalities beyond those specifically discussed in reference to FIG. 3. Examples of such alternative or additional functionalities will be discussed in reference to the flow diagrams discussed below.

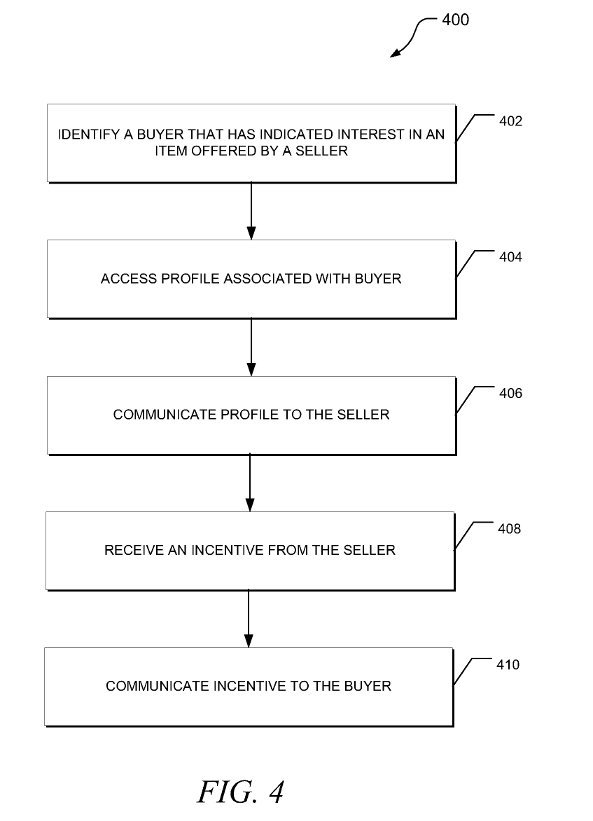

FIG. 4 is a flow diagram of a general overview of a method 400, in accordance with an embodiment, for facilitating a transaction of an item between a seller and a buyer. In one embodiment, the method 400 may be implemented by the item incentive module 230 and employed in the application server 218 of FIG. 2. As depicted at 402 in FIG. 4, the item incentive module identifies that a buyer has indicated interest in an item offered by a seller. Interest may be identified by detecting that a buyer has added the item to a watch list, a shopping cart, a wish list, or other indication of which explanations are provided in more detail below.

After a buyer has been identified, the item incentive module then locates and retrieves the profile associated with the buyer at 404. In this embodiment, it should be noted that the buyer has provided his profile to the network-based commerce system, but has not previously provided his profile information to the seller. Accordingly, the seller does not have the buyer's profile prior to listing the item on the network-based commerce system or prior to the buyer indicating interest in the item because, in part, the buyer has not yet been identified.

The item incentive module then communicates (e.g., push or pull) the accessed profile to the seller at 406. Upon receipt of the profile, the seller may compose an additional incentive based on the buyer's profile and communicate this incentive to the network-based commerce system. As used herein, an “incentive” refers to a modification of the original offer, the modification of which is to further incentivize or motivate the targeted buyer to acquire the item. The network-based commerce system can provide the seller with a variety of different incentive options. An example of an incentive includes an additional discount on the item. Such an additional discount may be an additional percentage or monetary amount off the original offered price. Another example of an incentive is reduced shipping cost or a different shipping service. The seller may learn that the buyer is located close to the seller and therefore, may provide an incentive with reduced shipping cost when compared to the shipping cost included in the initial offer. Alternatively, the seller may offer an incentive with a different shipping service when compared to the shipping service included the initial offer. Yet another example of an incentive is a coupon for future purchases with the same seller. An incentive can also include a bundle deal where the seller would provide a discount on a number of items bundled together if the buyer includes the interested item in the bundle.

Upon receipt of the incentive at 408, the network-based commerce system then communicates this incentive to the buyer at 410. In view of the additional incentive provided by the seller, the buyer may accept the incentive by, for example, communicating a message to the network-based commerce system that he wants to acquire the item. By allowing a seller to initiate an incentive to a buyer based on the buyer's profile, the network-based commerce system may allow the seller to better target or personalize his offer based on the individual needs of each buyer.

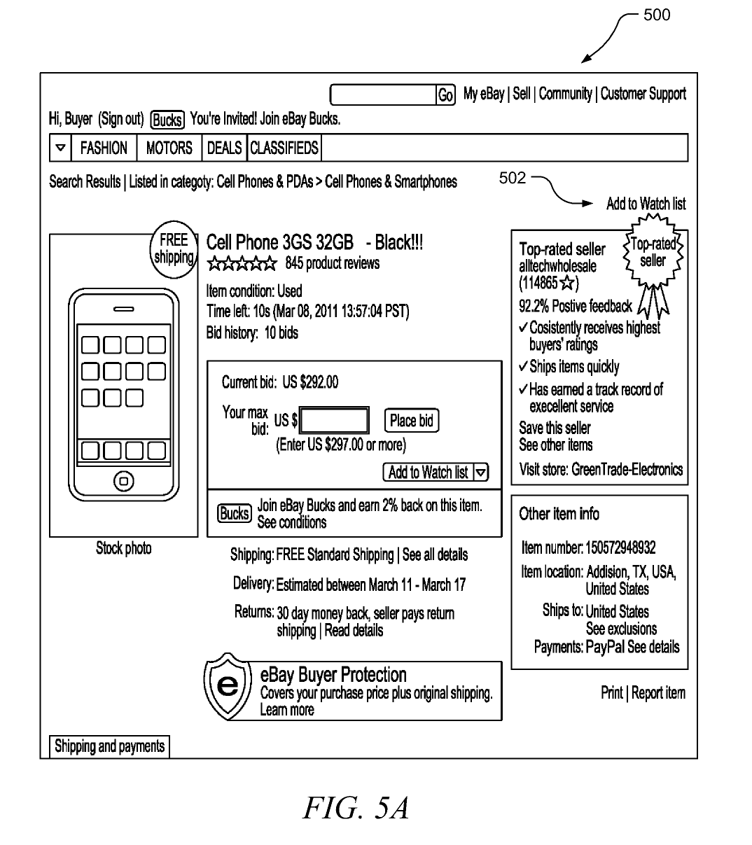

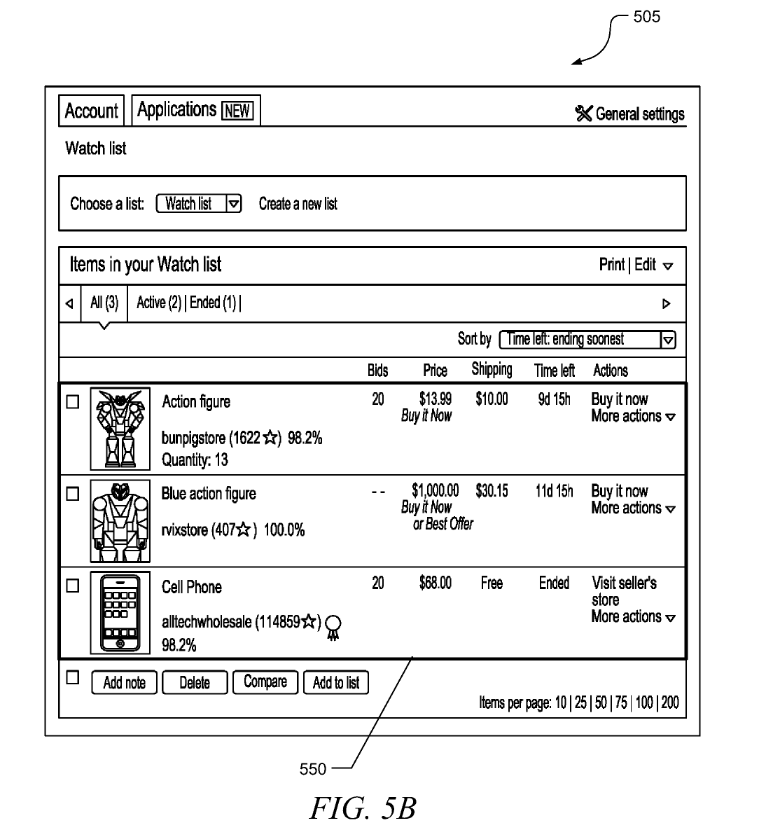

FIGS. 5A and 5B are graphical user interfaces 500 and 505 illustrating the identification of a buyer indicating interest in an item offered by the seller, in accordance with an example embodiment. In one example, the item incentive module can identify a buyer indicating interest in an item by detecting that a buyer has added the item to a watch list, which is a list of items that require close surveillance by the buyer for possible action in the future. FIG. 5A illustrates a graphical user interface 500 depicting a listing of a cell phone item in an online auction. This graphical user interface 500 includes a “Watch list” interface region 502 that enables a buyer or other user to add the listed item to his watch list by interacting with (e.g., clicking) the interface region 502.

FIG. 5B illustrates another graphical user interface 505 depicting a watch list of various items added by a buyer. Here, the graphical user interface 505 includes interface region 550 that displays a listing of all items added by the buyer to the watch list. For example, the cell phone item appears in the interface region 550 after the buyer adds the cell phone item to his watch list by clicking on the interface region 502 of FIG. 5A.

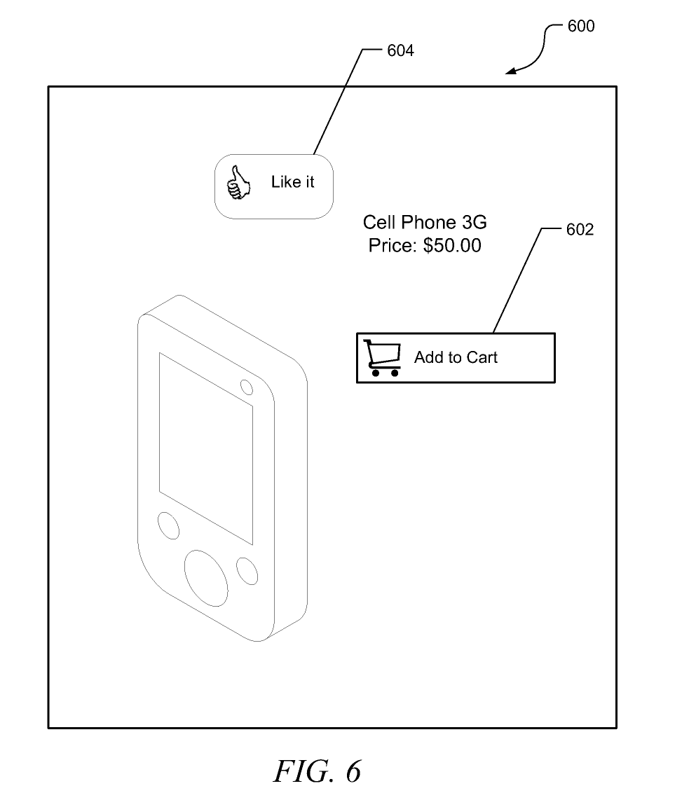

FIG. 6 is a graphical user interface 600 illustrating the identification of a buyer indicating interest in an item offered by the seller, in accordance with another example embodiment. Here, graphical user interface 600 depicts a listing of a cell phone item for sale in an online store. The graphical user interface 600 includes “Add to Cart” interface region 602 and “Like it” interface region 604. In this example, the item incentive module can identify a buyer indicating interest in an item by detecting that the buyer has added or saved the item to a shopping cart or indicated that he likes this item. Interface region 602 enables a buyer to add the listed item to his shopping cart, which is a listing of items potentially intended by the buyer for purchase, by interacting with (e.g., clicking) interface region 602. Interface region 604 enables a buyer to share the item with other users.

It should be noted that there are a variety of other different methodologies by which a buyer can indicate his interest in a particular item. In other example embodiments, an item incentive module can identify a buyer indicating interest in a particular item by detecting that the buyer has added the item to a favorites list, research list, save for later list, wish list, gift idea list, or a registry list.

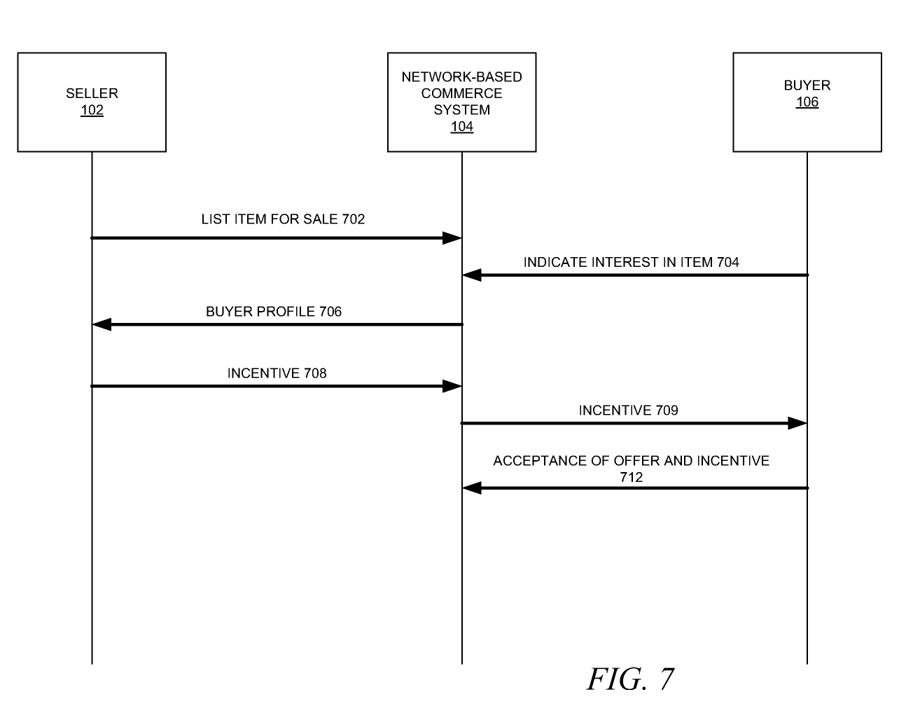

FIG. 7 is a message-sequencing diagram illustrating various messages transmitted between a buyer 106 and a seller 102 in the transaction of an item, in accordance with some embodiments of the present invention. As depicted in FIG. 7, the message sequencing diagram depicts representations of a seller 102, a network-based commerce system 104, and a buyer 106. At 702, the seller 102 transmits a message to the network-based commerce system 104 with an offer for a sale of an item. Upon receipt of the message, the network-based commerce system 104 composes a listing of the item for sale, and publishes this listing online. After the listing is published, the buyer 106 viewing the listing may indicate an interest in the item at 704 by taking a particular action that is detected by the network-based commerce system 104. As described above, the network-based commerce system 104 can identify the buyer indicating interest by, for example, detecting the buyer 104 adding or having saved the item to a watch list or a shopping cart.

Upon identifying that the buyer 106 has indicated interest in the item, the network-based commerce system 104 then accesses a profile associated with the buyer 106 and communicates the buyer profile to the seller 102 at 706. In view of this buyer profile, the seller 102 may then compose and communicate an incentive to the network-based commerce system 104 at 708. As described above, examples of such incentives include a further discount on the item and/or reduced shipping costs. The network-based commerce system 104 receives the incentive from the seller 102 and then communicates this incentive to the buyer 106 at 709. In some embodiments, the seller 102 can set or specify an expiry time for the incentive in the network-based commerce system 104. In other words, the seller 102 can limit the time period with which the buyer 106 can accept the incentive. The seller may impose additional constraints for the incentive. As an example, if the seller makes an offer with reduced shipping cost, the offer may be valid if the buyer requests the item to be shipped to the same location that was communicated to the seller as pap of the profile information of the buyer.

In view of the added incentive, the buyer 106 can communicate an acceptance of both the offer and the additional incentive to the network-based commerce system 104 at 712. Upon receipt of this acceptance, the network-based commerce system 104 then completes the transaction between the seller 102 and the buyer 106.

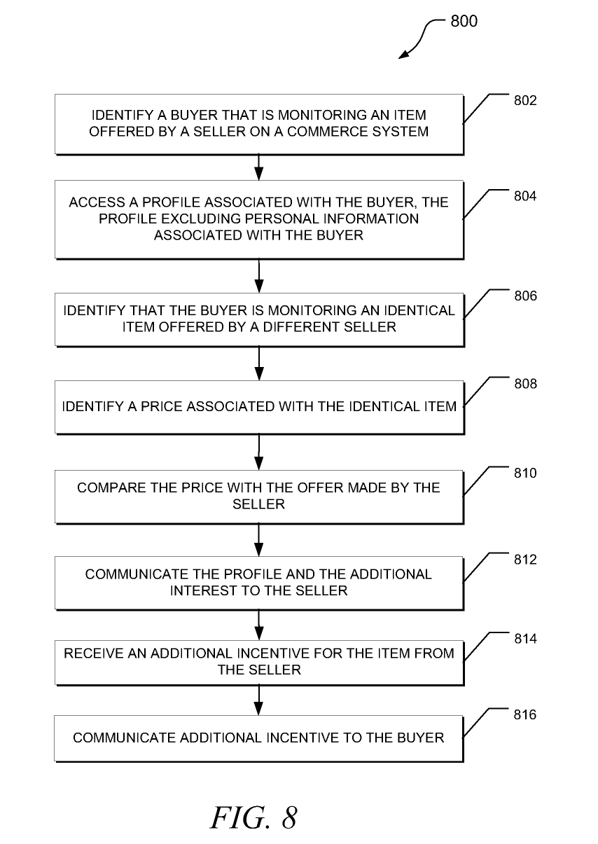

FIG. 8 depicts a flow diagram of a method 800, in accordance with some alternate embodiments, for facilitating a transaction of an item between a seller and a buyer. Similarly, this method 800 may be implemented by the item incentive module 230 and embodied in an application server 218 of FIG. 2. As depicted in FIG. 8 at 802, the item incentive module identifies a buyer that is monitoring an item, which was offered for sale by a seller on a network-based commerce system. The profile associated with the identified buyer is then accessed at 804 from, for example, a database that stores the profiles of different buyers or users. In one embodiment, this profile excludes personal information associated with the buyer. As used herein, “personal information” refers to information that can be used to ascertain a user's identity. In one example, personal information is information about an individual whose identity is apparent or can reasonably be ascertained from the information. In some embodiments, personal information include a user's name, street address, phone number, drivers license number, passport number, and/or social security number. Non-personal information includes a buyer's gender, partial address (e.g., city, state, county, country, and zip code), search history, age bracket, feedback profile (e.g., feedback ratings and feedback comments), and purchase history.

The item incentive module can also identify that the buyer has indicated additional interest in another item. In one embodiment, this additional item can be a different item offered by the same or a different seller. In an alternate embodiment, as depicted at 806 of FIG. 8, this additional item can be an identical item offered by a different seller. If the buyer has indicated interest in an identical item, the item incentive module can identify, at 808, a price associated with the identical item and compare the price with the offer made by the seller at 810. The comparison indicates that the price of the identical item is higher than, equal to, or lower than the price offered by the seller. In addition to the price, the item incentive module can also extract or identify other information associated with the additional item. For example, in an online auction, the item incentive module can further identify an auction expiration time associated with the additional item. In another example, the item incentive module can further identify or extract the title or a description of the additional item.

With the comparison having been made, the item incentive module communicates the profile and the additional interest to the seller at 812. The item incentive module can communicate a wide variety of different additional interests to the seller. In one embodiment, the item incentive module can transmit a message to the seller identifying an additional item (e.g., description or title of the additional item) in which the buyer has expressed interest. In another embodiment, the item incentive module can transmit the comparison (e.g., lower price, higher price, or equal price) to the seller. In yet another embodiment, the item incentive module can transmit the price of the additional item to the seller.

In view of the buyer's profile and additional interest, the seller can then provide an additional incentive. For example, upon having received information that the buyer is watching another identical item having a lower price, the seller may provide an incentive that further reduces the price of the listed item. Alternatively, upon having received information that the buyer is watching another identical item where the auction expiration time for that identical item will be ending soon, the seller can provide an incentive in the form of a coupon for a next purchase to hopefully get the buyer to accept his offer before the auction expiration time. In yet another example, upon having received information that the buyer has expressed interest in other items that are related to the item offered by the seller, the seller can provide an incentive in the form of a bundled deal where if the buyer additionally purchases all these other items, the buyer will receive an additional discount.

At 814, the item incentive module receives an additional incentive for the item from the seller and then communicates this additional incentive to the buyer at 816. In view of this additional incentive, the buyer may accept both the incentive and the offer by transmitting a message to the network-based commerce system that he (the buyer) wants to acquire the item.

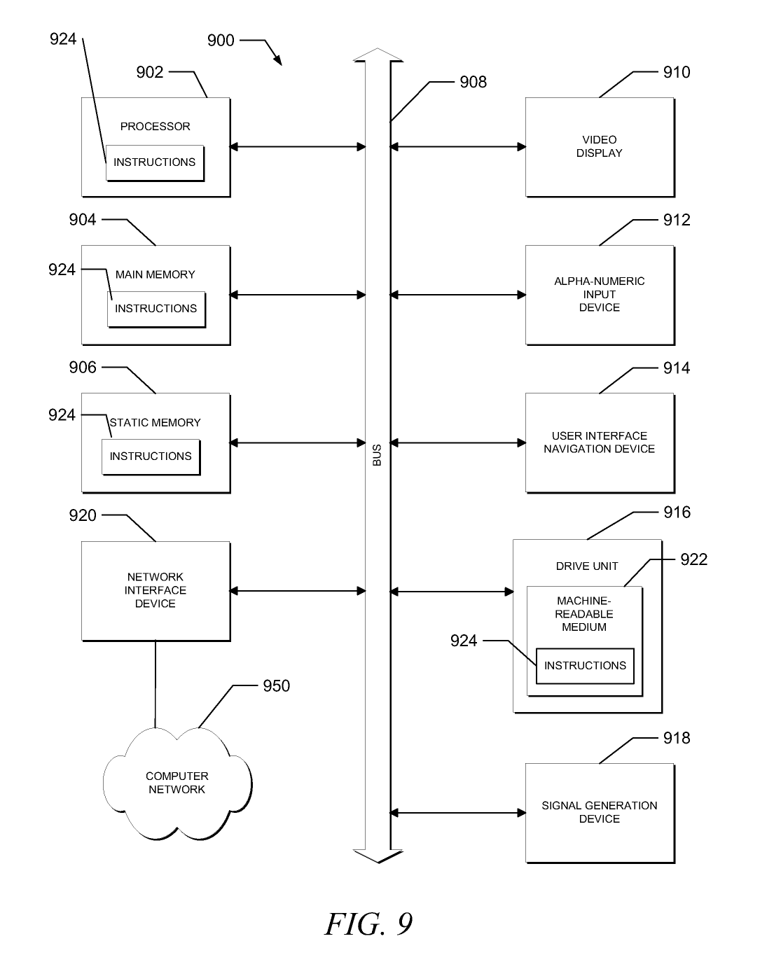

FIG. 9 depicts a block diagram of a machine in the example form of a processing system 900 within which may be executed a set of instructions for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment.

The machine is capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example of the processing system 900 includes a processor 902 (e.g., a central processing unit (CPU), a graphics processing unit (GPU) or both), a main memory 904 (e.g., random access memory), and static memory 906 (e.g., static random-access memory), which communicate with each other via bus 908. The processing system 900 may further include video display unit 910 (e.g., a plasma display, a liquid crystal display (LCD) or a cathode ray tube (CRT)). The processing system 900 also includes an alphanumeric input device 912 (e.g., a keyboard), a user interface (UI) navigation device 914 (e.g., a mouse), a disk drive unit 916, a signal generation device 918 (e.g., a speaker), and a network interface device 920.

The disk drive unit 916 (a type of non-volatile memory storage) includes a machine-readable medium 922 on which is stored one or more sets of data structures and instructions 924 (e.g., software) embodying or utilized by any one or more of the methodologies or functions described herein. The data structures and instructions 924 may also reside, completely or at least partially, within the main memory 904 and/or within the processor 902 during execution thereof by processing system 900, with the main memory 904 and processor 902 also constituting machine-readable, tangible media.

The data structures and instructions 924 may further be transmitted or received over a computer network 950 via network interface device 920 utilizing any one of a number of well-known transfer protocols (e.g., HyperText Transfer Protocol (HTTP)).

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., the processing system 900) or one or more hardware modules of a computer system (e.g., a processor 902 or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an ASIC) to perform certain operations. A hardware module may also comprise programmable logic or circuitry (e.g., as encompassed within a general-purpose processor 902 or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor 902 configured using software, the general-purpose processor 902 may be configured as respective different hardware modules at different times. Software may accordingly configure a processor 902, for example, to constitute a particular hardware module at one instance of time and to constitute a different hardware module at a different instance of time.

Modules can provide information to, and receive information from, other modules. For example, the described modules may be regarded as being communicatively coupled. Where multiples of such hardware modules exist contemporaneously, communications may be achieved through signal transmissions (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices and can operate on a resource (e.g., a collection of information).

The various operations of example methods described herein may be performed, at least partially, by one or more processors 902 that are temporarily configured (e.g., by software) or permanently configured to perform the relevant operations. Whether temporarily or permanently configured, such processors 902 may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors 902 or processor-implemented modules. The performance of certain of the operations may be distributed among the one or more processors 902, not only residing within a single machine, but deployed across a number of machines. In some example embodiments, the processors 902 may be located in a single location (e.g., within a home environment, an office environment or as a server farm), while in other embodiments, the processors 902 may be distributed across a number of locations.

While the embodiment(s) is (are) described with reference to various implementations and exploitations, it will be understood that these embodiments are illustrative and that the scope of the embodiment(s) is not limited to them. In general, techniques for facilitating transactions between buyers and sellers may be implemented with facilities consistent with any hardware system or hardware systems defined herein. Many variations, modifications, additions, and improvements are possible.

Plural instances may be provided for components, operations or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the embodiment(s). In general, structures and functionality presented as separate components in the exemplary configurations may be implemented as a combined structure or component. Similarly, structures and functionality presented as a single component may be implemented as separate components. These and other variations, modifications, additions, and improvements fall within the scope of the embodiment(s).

What is claimed is:

1. A network-based commerce system that facilitates a transaction of an item between a seller and a buyer, the network-based commerce system comprising:
an interest identification module configured to identify the buyer that has indicated interest in the item offered by the seller, the buyer not having previously provided to the seller a profile associated with the buyer;
a profile extraction module configured to access the profile and to communicate the profile to the seller; and
an initiate offer module configured to receive an incentive from the seller and to communicate the incentive to the buyer, the incentive being made based on the communication of the profile to the seller.

2. The network-based commerce system of claim 1, wherein the interest identification module is further configured to identify that the buyer has indicated additional interest in an additional item and to communicate the additional interest to the seller, wherein the incentive is made based on the communication of the profile and the additional interest to the seller.

3. The network-based commerce system of claim 1, wherein the transaction is an online auction for the item, wherein the interest identification module is further configured to identify that the buyer has indicated additional interest in an additional item, to identify an auction expiration time associated with the additional item, and to communicate the additional interest and the auction expiration time to the seller, and wherein the incentive is made based on the communication of the profile, the additional interest, and the auction expiration time to the seller.

4. A method at a network-based commerce system that facilitates a transaction of an item between a seller and a buyer, the method comprising:
identifying the buyer that has indicated interest in the item offered by the seller, the buyer not having previously provided to the seller a profile associated with the buyer;
retrieving the profile associated with the buyer;
communicating the profile to the seller;
receiving an incentive from the seller, the incentive being made based on the communication of the profile to the seller; and
communicating the incentive to the buyer.

5. The method of claim 4, further comprising receiving an acceptance of the offer and the incentive from the buyer after the communication of the incentive.

6. The method of claim 4, further comprising:
identifying that the buyer has indicated additional interest in an additional item; and
communicating the additional interest to the seller,
wherein the incentive is made based on the communication of the profile and the additional interest to the seller.

7. The method of claim 6, further comprising:
identifying a price associated with the additional item; and
communicating the price to the seller,
wherein the incentive is made based on the communication of the profile, the additional interest, and the price to the seller.

8. The method of claim 4, wherein the transaction is an online auction for the item, the method further comprising: identifying that the buyer has indicated additional interest in an additional item;
identifying an auction expiration time associated with the additional item; and
communicating the additional interest and the auction expiration time to the seller,
wherein the incentive is made based on the communication of the profile, the additional interest, and the auction expiration time to the seller.

9. The method of claim 4, wherein the identification of the buyer comprises identifying the buyer adding the item to a watch list.

10. The method of claim 4, wherein the identification of the buyer comprises identifying the buyer adding the item to a shopping cart.

11. The method of claim 4, wherein the identification of the buyer comprises identifying the buyer adding the item to a wish list.

12. A non-transitory machine-readable medium that stores instructions, which, when performed by a machine, cause the machine to perform operations comprising:
identifying a buyer that is monitoring an item that is offered by a seller on a network-based commerce system, the buyer not having previously provided to the seller a profile associated with the buyer;
retrieving the profile associated with the buyer, the profile excluding personal information associated with the buyer;
communicating, from the network-based commerce system, the profile to the seller;
receiving an additional incentive for the item from the seller, the additional incentive being made based on the communication of the profile to the seller; and communicating, from the network-based commerce system, the additional incentive to the buyer.

13. The non-transitory machine-readable medium of claim 12, further comprising:
identifying that the buyer is monitoring an identical item offered by a different seller; identifying a price associated with the identical item;
comparing the price with the offer made by the seller; and
communicating the comparison to the seller,
wherein the additional incentive is made based on the communication of the profile and the comparison to the seller.

14. The non-transitory machine-readable medium of claim 12, wherein the network-based commerce system facilitates an online auction of the item.

15. The non-transitory machine-readable medium of claim 12, wherein the profile includes a search history of the buyer.

16. The non-transitory machine-readable medium of claim 12, wherein the profile includes a purchase history of the buyer.

17. The non-transitory machine-readable medium of claim 12, wherein the profile includes a gender of the buyer.

18. The non-transitory machine-readable medium of claim 12, wherein the profile includes a location of the buyer.

19. The non-transitory machine-readable medium of claim 18, wherein the additional incentive includes reduced shipping cost.

20. The non-transitory machine-readable medium of claim 18, wherein the offer made by the seller designates a base shipping service, and wherein the additional incentive includes a different shipping service compared to the base shipping service.

21. A network-based commerce system that facilitates a transaction of an item between a seller and a buyer, the network-based commerce system comprising:
an interest identification means configured to identify the buyer that has indicated interest in the item offered by the seller;
a profile extraction means configured to access a profile associated with the buyer and to communicate the profile to the seller; and
an initiate offer means configured to receive an incentive from the seller, the incentive being made based on the communication of the profile to the seller, and to communicate the incentive to the buyer.
